(19) United States
(12) Patent Application Publication
(10) Pub. No.: US 2008/0312945 A1
(43) Pub. Date: Dec. 18, 2008

(54) Divided title property allocation method and system

(76) Inventor: Mark White, Evanston, IL (US)

Correspondence Address: R. Blake Johnson;DLA Piper US LLP, Suite 1900, 203 N. LaSalle St., Chicago, IL, 60601, US

(21) Appl. No.: 12/079,572

(22) Filed: Mar. 24, 2008

Related U.S. Application Data
(60) Provisional application No. 60/919,708, filed on Mar. 22, 2007.

(51) Int. Cl. G06Q 99/00; G06Q 30/00

(52) U.S. Cl. 705/1

(57) ABSTRACT

A system and method divides the full undivided or fee simple property rights bundle of an individual property into at least two distinct property titles, each encompassing distinct rights and available to distinct owners. One divided title can be a possessing title that encompasses the single unbundled property right of possession and the second divided title can be a controlling-title that encompasses all unbundled full undivided or fee simple rights to the property other than possession. As a result, transactions that transfer physical possession of the property without transferring other rights that control modifications to the property can be accomplished. The system and method permits other divisions of the full undivided or fee simple property rights bundle to achieve other objectives property owners may desire.

### CLAIM OF PRIORITY.

This application claims priority from U.S. Provisional Patent Application Ser. No. 60/919,708, filed Mar. 22, 2007.

### FIELD OF THE INVENTION

The invention relates generally to resource allocations and, more particularly, to a system and method that unbundles the full undivided property rights bundle associated with tangible personal, heirloom and real property.

### BACKGROUND

Various methods of unbundling full undivided property rights to tangible personal property exist, including trusts, bailments, leases, fractional gifts/sales, sic utere rights, moral rights, droit de suite, and security interests in personal property. These have been directed at various forms of tangible personal property, including depreciating assets such as automobiles and industrial equipment as well as non-depreciating assets such as artworks and collectibles. Even more methods of unbundling fee simple property rights to real property exist, including trusts, bailments, leases, fractional gifts/sales, sic utere rights, plus all kinds of estates in land dating from the middle ages (e.g. ground leases, rights to forage, windfall wood, springing uses, life estates with remainder interests, estates that arise upon someone's demise, joint tenancy, cotenancy, etc.). Some real property unbundling methods apply to heirloom property that have personal property characteristics, making property definitions and applicable unbundlings a complex area of law. These myriad resource allocation improvement methods have developed over centuries of real property transactions in which legal innovators responded to perceived needs.

As with property generally, the common law's approach to tangible personal, heirloom and real property ownership involves not only the tangible object, heirloom or real estate itself, but a bundle of property rights associated with ownership of that object, heirloom or land. This “bundle of rights” includes the right to possess, the right to sell, the right to lend, the right to lease, the right to leave as an inheritance, the right to modify, the right to destroy, the right to consume, the right to name, the right to withhold, the right to security, the right to partition, the right to give, the right to use, the right to manage, the right to transport, the right to transmit, the right to enjoy, the right to income, the right to reproduce, the right to distribute, the right to display, and more, including the lack of time limits on these rights. The owner's property rights include anything anyone has ever thought to do with property, and since the common law permits what it doesn't prohibit, if someone invents something to do with tangible personal property or heirloom property, the owner's property rights include that as well, absent a prior prohibition. Thus, the bundle of rights also includes the right to create personal property or heirloom property derivatives from the personal or heirloom property.

The common law can and does place limits on the rights included in the bundle, and has done so particularly with the right to use property. The common law limits uses of property with the doctrine of sic utere tuo, ut alienum non laedas (use your property so as not to harm another's). Sic utere doctrine says the original bundle of rights includes all rights to use your property in ways that do not harm another, but does not include any rights to use your property in any ways that harm another. Legislation can also limit the rights in the bundle, as when Congress legislated moral rights or integrity rights, which take the right to modify an artwork out of the subsequent owner's bundle and put it into the original artist's bundle. These limits demonstrate other forms of unbundling.

Securitization methods exist that create financial derivatives such as mortgage-backed securities. Securitization adds value and flexibility to resource allocations by unbundling the rights to cash flows generated by intangible personal property (i.e., financial assets), real property (i.e., real estate portfolios) and tangible personal property (i.e., inventories) into separate bundles (i.e., tranches), with each tranche tailored to provide characteristics (e.g., risk, maturity, etc.) so each separate cash flow bundle best meets individual user needs, while still leaving ownership of the other property rights beyond the right to cash flows with other owners. Securitization is a variation on older common law themes of trusts, which have separated beneficial ownership (encompassed by the equitable title) from legal ownership (encompassed by the legal title), and security interests in personal property where the debtor has title and possession while the creditor has a lien with the ability to take title and possession in the event of default. To date, securitizations have applied unbundling methods in myriad ways to financial assets, and in increasing numbers of ways to rights to cash flows generated by real property assets as well as tangible personal property assets such as current inventories.

Other patented methods have unbundled tangible personal property rights into separate bundles in different ways. For example, U.S. Pat. Nos. 5,802,501; 6,167,384; 6,192,347; 6,760,709 and 7,107,239 to Graff present methods to calculate valuations for tangible personal property decomposed into primary and secondary equity interests, term and remainder interests, and even contingent interests in the tangible personal property associated with at least one lease default condition for the property. However, in these decompositions, all the property rights in the bundle belong to either one party or another depending on the condition, or the decomposition is for a term. The classic property types (estates in real property) are fee simple, life estate, reversion and remainder. In another example, U.S. Pat. No. 7,069,252 to Ishimi, et al, assumes three titles to cargo about to be transferred, namely, “title to possess,” “title to own,” and “other titles.” That invention electronically passes title from the present owner to the future owner of the cargo by giving instructions to the possessor of the cargo (transportation company), but the possessor of the cargo just has a bailment, rather than a literal title to possess.

In the specific field of management of museum permanent collections, examples of property rights unbundling include collection rentals and fractional ownership. Leases are very similar in concept to possessing-titles, in the sense that a lease, like a possessing-title, gives possession of the tangible personal property to the lessee for a term while the lessor retains title the property, just as the possessor has possession of the tangible personal property while the controller retains controlling-title to the property.

Museums may have objects or heirlooms in storage that they are unlikely to display or research in the short-term, but may wish to display or research in the future. Storing these objects or heirlooms is expensive; the expense provides an uncertain, even dubious, current return to the museum. Museums currently may lease the objects or heirlooms to other collections to recoup some financial value, or may deaccession and sell the objects or heirlooms to recoup their complete financial value. Both of these alternatives raise objections among critics of current collection practices, who call on museums to heed other values besides financial values.

A museum that leases an object or heirloom from their permanent collection places the object or heirloom in possession of a counterparty that only has possession for a term. Since the counterparty derives no financial value from possession of the object or heirloom beyond that term, the counterparty has no financial incentive to care for the object or heirloom in a way that optimizes its condition beyond that term. That leads to incentive incompatibility with the museum, which does have a financial incentive to have the object or heirloom cared for in a way that optimizes its condition beyond that term. Leasing is a suboptimal solution to collection management issues.

A museum that deaccessions an object or heirloom from their permanent collection places the object or heirloom in complete control of the counterparty. The museum no longer has any control or ties to that object or heirloom. For critics who believe that objects or herilooms accessioned to a museum's permanent collection are a permanent responsibility of the museum, this loss of control makes deaccessioning a suboptimal solution to collection management issues.

Richard Stroup and Matthew Brown (Regulation, Vol. 23, No. 4) have proposed a market method for protecting artifacts subject to archaeological looting. This example demonstrates that others have devoted considerable thought about methods and systems to achieve flexible control over tangible personal property or heirlooms without taking the next step of dividing titles. Stroup and Brown note that a free market in antiquities can increase the resources available for the preservation of artifacts and specimens and the analysis of source sites by letting landowners profit from scientific discoveries on their land. For example, Landowners would contract with archaeological organizations that would develop scientific resources for sale on collector markets much as geological organizations (e.g., miners and drillers) develop mineral resources for sale on commodity markets. The excellent provenance and provenience provided by better archaeological organizations would increase the value of objects and heirlooms, as would later research. Stroup and Brown note the difference between scientific samples and commodities, and describe a registry that maintains and updates ownership information so that discoverers can recall specimens for non-destructive analysis or even repurchase, at the original sales price, artifacts or specimens for destructive testing (with the insurance companies that insure the objects and heirlooms providing the updates). However, they do not discuss how to fairly implement the recalls or repurchases, nor do they address the incentive incompatibility of letting museums repurchase objects or heirlooms at a fixed price when market prices will vary.

Equity Trust Inc.'s method for protecting community-based-agriculture lands subject to non-agricultural development provides methods and systems to achieve flexible control over sensitive real property. More specifically, Equity Trust, Inc., a non-profit community development organization, provides technical and financial help to community-based economic development projects and organizations in the United States and abroad. Equity Trust specializes in land tenure, offering the Community Land Trust (CLT) form that helps meet immediate individual needs while preserving long-term security for communities. CLTs are nonprofit organizations that acquire real estate to benefit their local community by providing access to affordable land, housing, and fresh produce for low-income residents. CLTs distinguish between land and improvements, with the CLT permanently holding or controlling the land, and the individuals using the land owning improvements personally. They use specialized long-term ground leases and/or conservation easements to manage long-term use and allocation of agricultural land. Both leases and easements are forms of “shared ownership” that separate the rights in a “bundle” of ownership rights to give a farmer long-term rights to develop, improve, and use a farmstead and farmlands, and another entity—a CLT or other stewardship institution—the right to oversee and regulate this use. Both forms can prohibit or restrict non-agricultural development and/or land uses, including ecologically damaging practices, and both grant a purchase option that gives the CLT significant control over ownership transfers, letting the CLT ensure that farmers can use the land at costs that farmers can afford. Both regulate activities on the land with great flexibility. Either may, for instance, simply require agricultural use, broadly defined, or either may closely regulate agricultural practices—for instance, requiring organic or biodynamic farming and/or a detailed land management plan. Long-term ground leases and conservation easements do differ in fundamental ways, however. With easements, the farmer owns the fee interest in the property—both land and improvements—while the CLT retains certain rights that perpetually restrict what any owner can do with the property and improvements. With long-term ground leases, the CLT retains fee interest in the land and transfers specific rights of possession and use, along with fee interest of buildings and other improvements, to the farmer. (Farmers buy existing improvements when entering the ground lease and may develop and own other improvements subject to lease terms).

One might argue that legal doctrines against equitable servitudes on a chattel (i.e., tangible personal property) and perpetuities on real property put title division out of bounds in Common Law jurisdictions, and that the Numerus Clausus doctrine similarly rules title division out in Civil Law jurisdictions. Nonetheless, a careful review of precedents shows that Common Law courts have accepted equitable servitudes on a chattel and perpetuities on real property when circumstances favor such methods, and the circumstances of widespread looting of objects, heirlooms and source sites certainly favor application here. Furthermore, treating museum pieces as heirloom property makes real property unbundling methods applicable, and some states allow perpetual trusts on personal and real property. While Common Law jurisdictions tend to lead in innovations for commercial law, Civil Law jurisdictions do vary in their applications of doctrines, and where a method makes sense, they have innovated as well.

It is therefore an object of the present invention to provide a system and method that unbundles the rights to tangible personal and real property directly, rather than unbundling rights to the cash flows they generate.

It is another object of the present invention to create a distinct form of the “title to possess” that is not a bailment.

It is another object of the present invention to provide a possessing title that is permanent (albeit subject to repossession at market prices). Such an arrangement changes incentives since a permanent possessing title gives the possessor the same incentive to protect the tangible personal property or heirloom property that the controller has with possessing and controlling titles to property in good condition being worth more than possessing and controlling titles to property in poor condition. This incentive compatibility is what makes the option of storing objects or heirlooms externally in the possession of possessors a feasible alternative for museums that have a positive responsibility to adequately care for their permanent collections.

It is still another object of the present invention to provide a system and method that lets museums and collectors implement recalls, repurchases and other interactions regarding the object or heirlooms in a manner that maintains incentive compatibility for both sides of the relationship.

It is still another object of the present invention to provide a system and method that offers the option of retaining ownership in the rights other than possession while transferring only the specific rights of possession and use.

### SUMMARY OF THE INVENTION

The present invention provides a class of tradable assets—possessing titles that embody the right of possession along with physical possession of the property—that adds flexibility to resource allocations of non-depreciating tangible personal property and heirloom property assets included in the permanent collections of museums and personal collections of individuals, as well as real property assets belonging to conservancies and individuals.

With the invention, the counterparty purchasing the possessing title derives financial value from possession of the object or heirloom into perpetuity, since the counterparty with possessing title has the right to sell that title embodying the right possession and rightful physical possession at a time of their choosing. The counterparty has the financial incentive to maximize the value of the possessing title by caring for the object or heirloom in a way that optimizes its condition permanently. That creates an incentive compatible with the museum's, which has the same financial incentive to have the object or heirloom cared for in a way that optimizes its condition in perpetuity, maximizing the value of the controlling-title with its attendant rights.

A museum that title divides an object or heirloom from their permanent collection in accordance with the present invention places the object or heirloom in physical possession of an incentive-compatible counterparty. Nonetheless, the museum still has substantial control and ties to that object or heirloom. The possessor must get permission from the controller to make any modifications to the object or heirloom, including, for example, undertaking any restoration or other physical alteration. For critics who believe that objects or heirlooms accessioned to a museum's permanent collection are a permanent responsibility of the museum, this permanent control over the object's or heirloom's modifications makes Title-Division a superior solution to collection management issues.

### BRIEF DESCRIPTION OF THE DRAWINGS

FIG. 1 is a flow chart showing property rights unbundled in accordance with a first embodiment of the system and method of the present invention;

FIG. 2 is flow chart showing the right of possession unbundled in accordance with a second embodiment of the system and method of the present invention;

FIG. 3 is a flow chart showing the title division from permanent collections in accordance with a third embodiment of the system and method of the invention;

FIG. 4 is a flow chart showing the title division of a permanent collection in accordance with a fourth embodiment of the system and method of the present invention;

FIG. 5 is a first embodiment of a title division agreement in accordance with the present invention;

FIG. 6 is a second embodiment of a title division agreement in accordance with the present invention;

FIG. 7 is a third embodiment of a title division agreement in accordance with the present invention;

FIG. 8 is an embodiment of a title division agreement between a possessor and a registry in accordance with the present invention;

FIG. 9 is an embodiment of a title division agreement between a controller and a registry in accordance with the present invention.

### DETAILED DESCRIPTION OF EMBODIMENTS

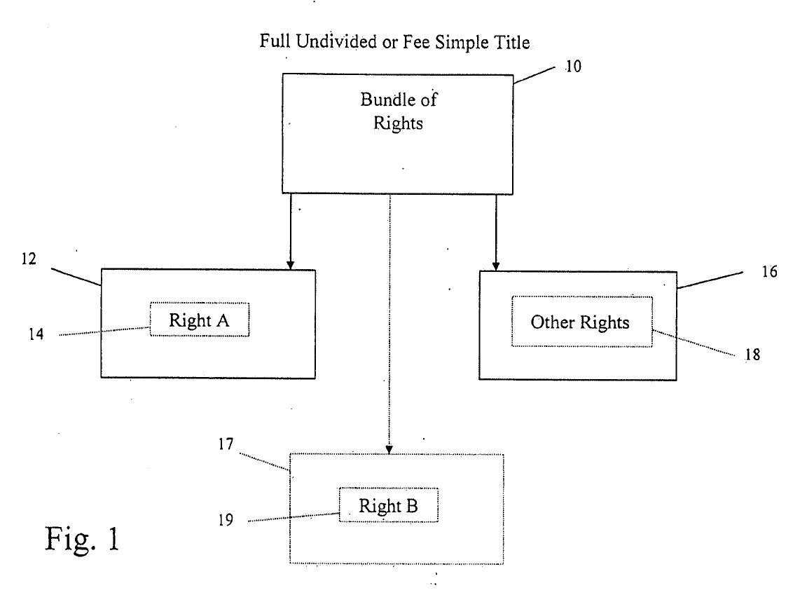

While the invention is described below in terms of unbundling a right of possession and other rights from the bundle of rights of a full divided or fee simple title, it is to be understood that, as illustrated in FIG. 1, the invention could be applied to unbundle multiple, alternative types of rights, such as Right A, Right B, etc., illustrated at 14 and 19, from the bundle of rights of a full undivided or fee simple title, indicated at 10 in FIG. 1. As a result, a 1st divided title 12 including Right A 14, a 2nd (or more) divided title 17 including Right B (or additional rights) 19 and a 3rd divided title 16 including the remaining other rights 18 are created. It should also be clear that there may be more than one divided title including more than one right unbundled from the full undivided or fee simple title bundle of rights.

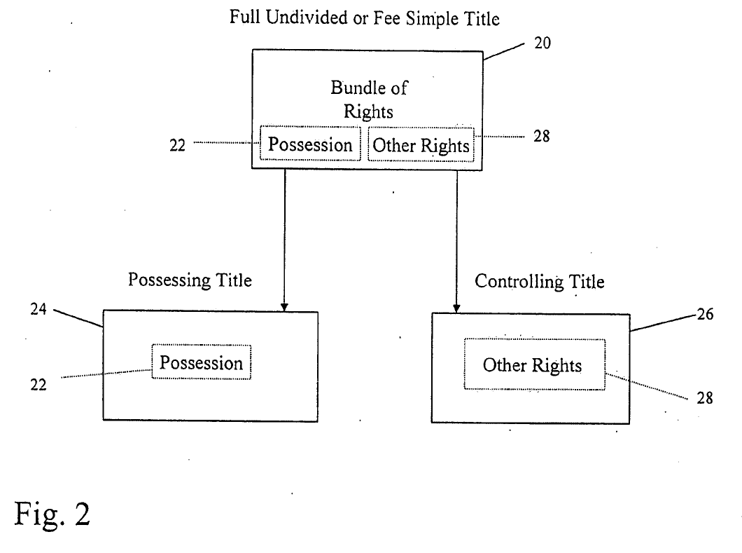

In an embodiment of the invention, with reference to FIG. 2, a full undivided or fee simple owner, and thus owner of a full undivided or fee simple title 20, of a single object of tangible personal property or heirloom of heirloom property or piece of real property unbundles the right of possession 22 from the other rights 28 of the bundle of rights of the full undivided or fee simple title. As a result, a possessing title 24, including the right of possession 22, and a controlling title 26, including the remaining other rights 28, are created.

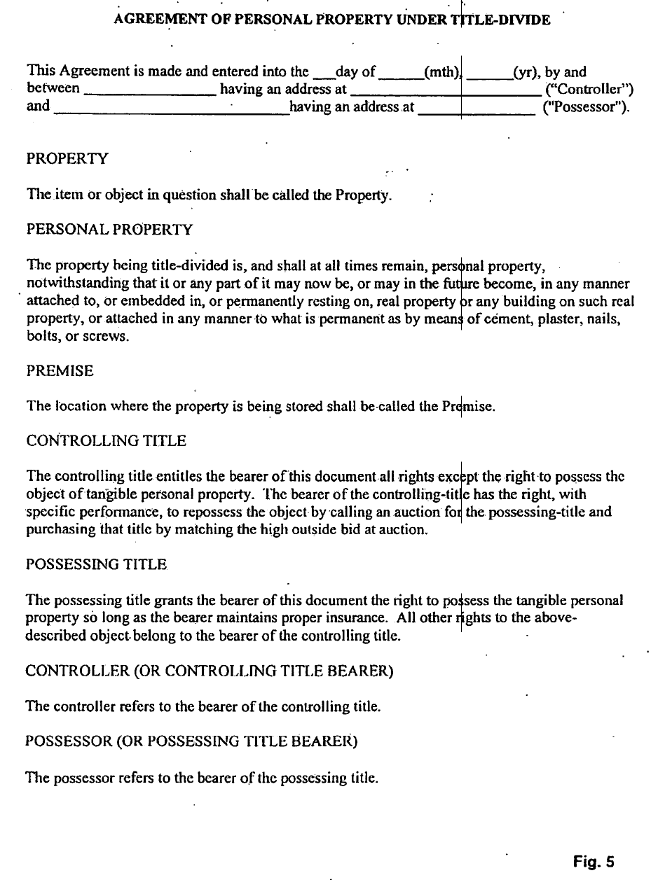

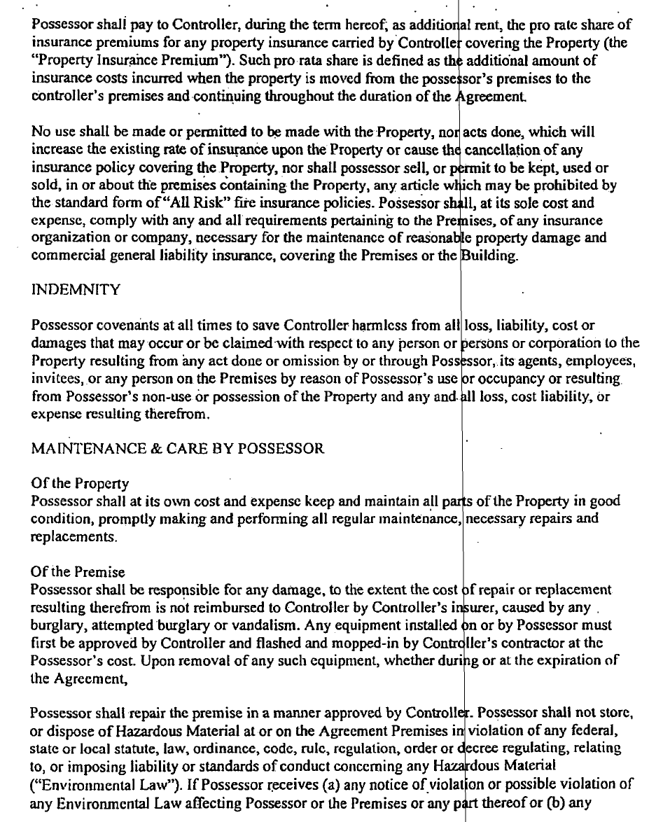

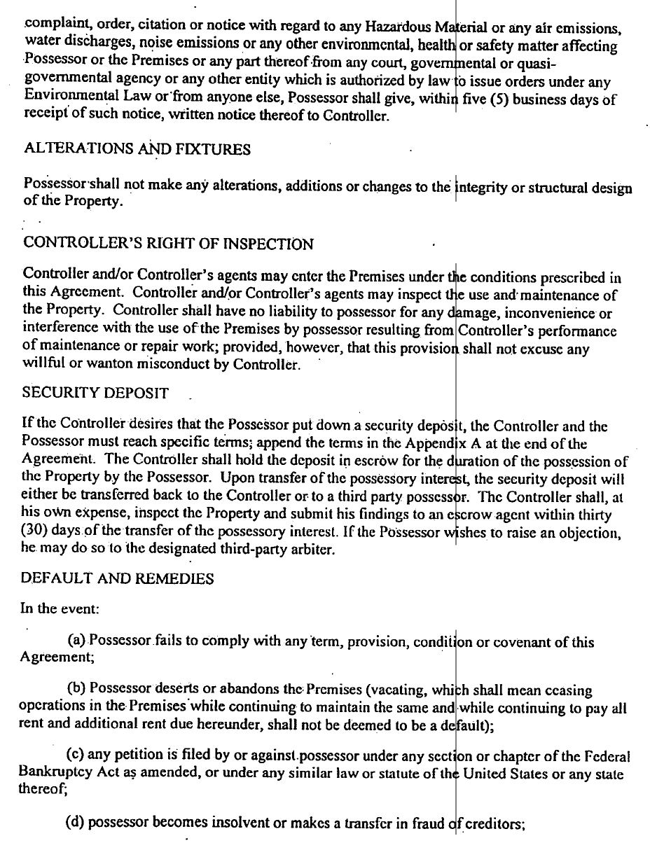

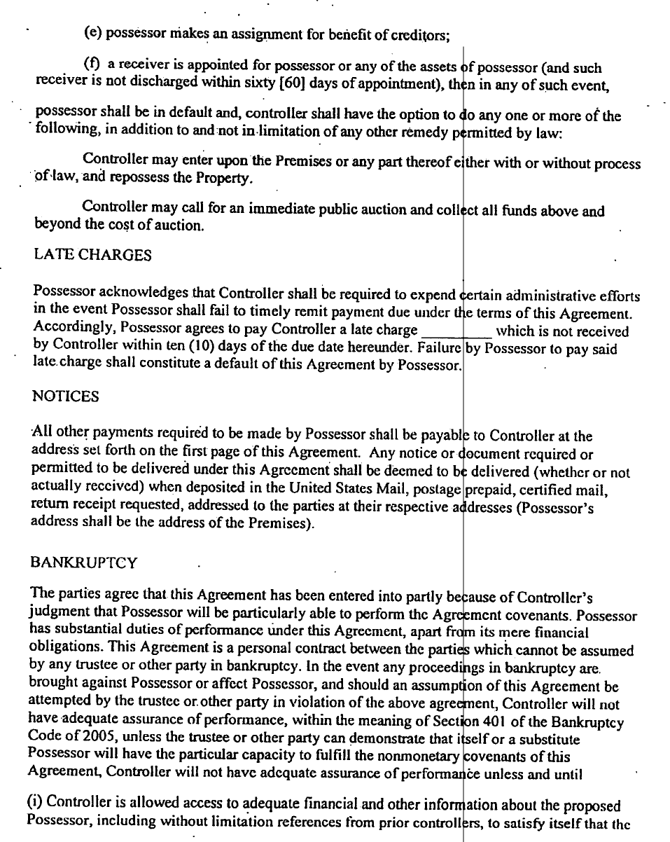

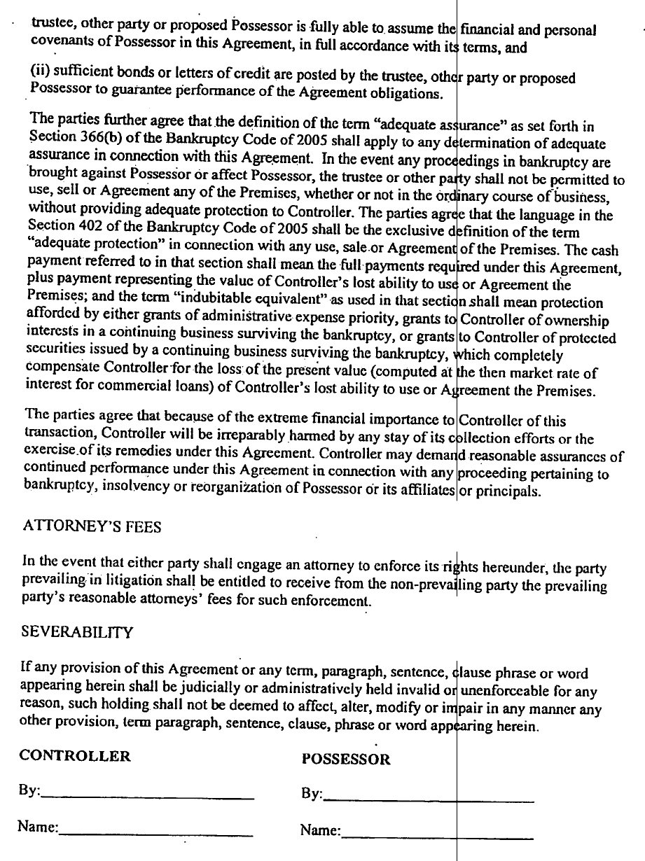

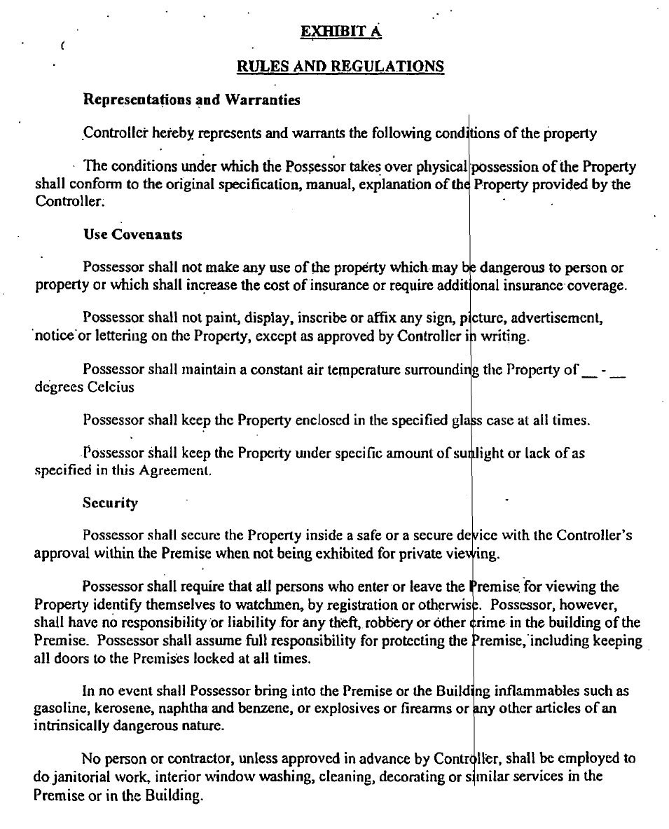

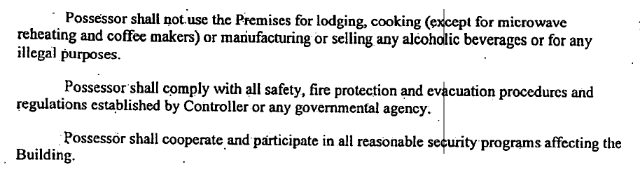

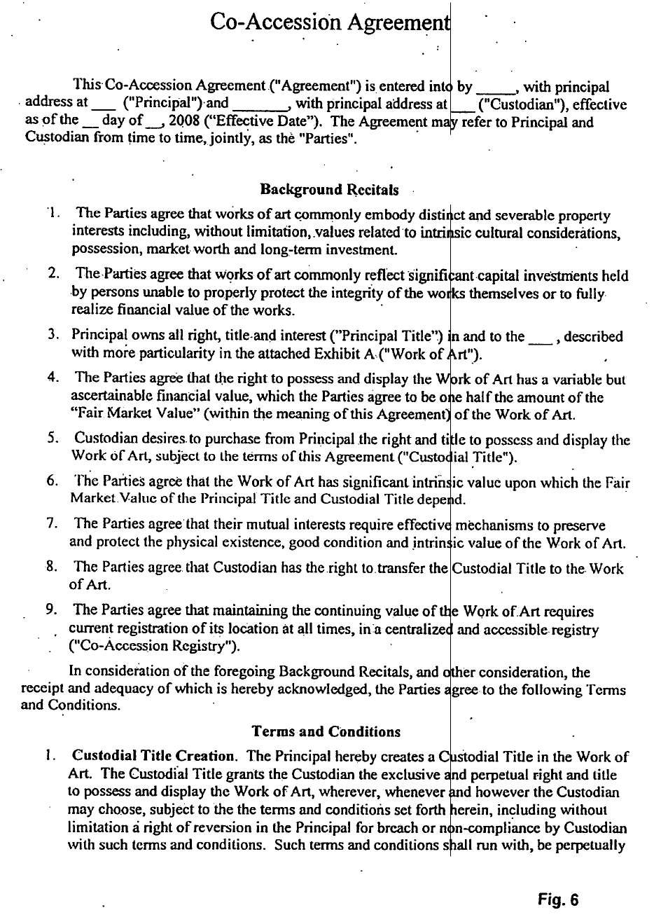

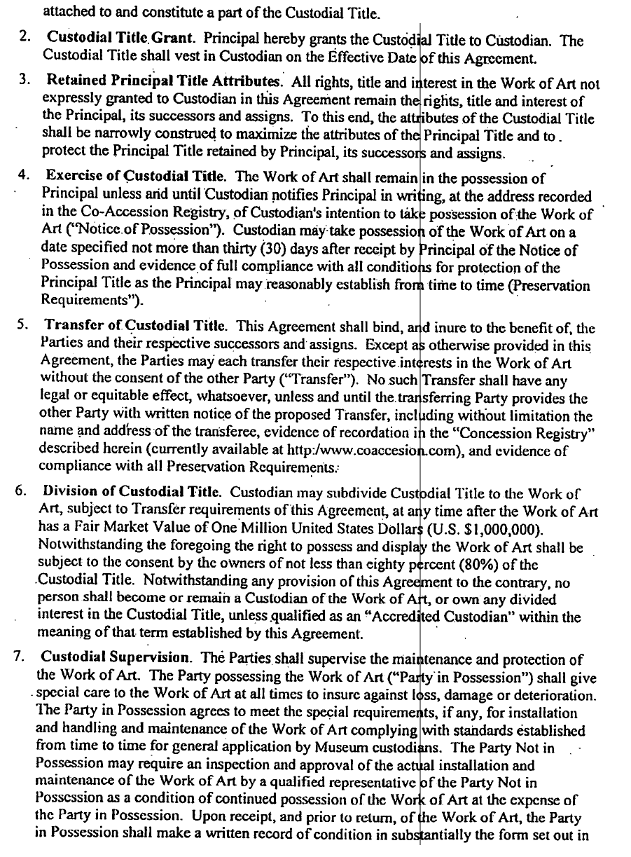

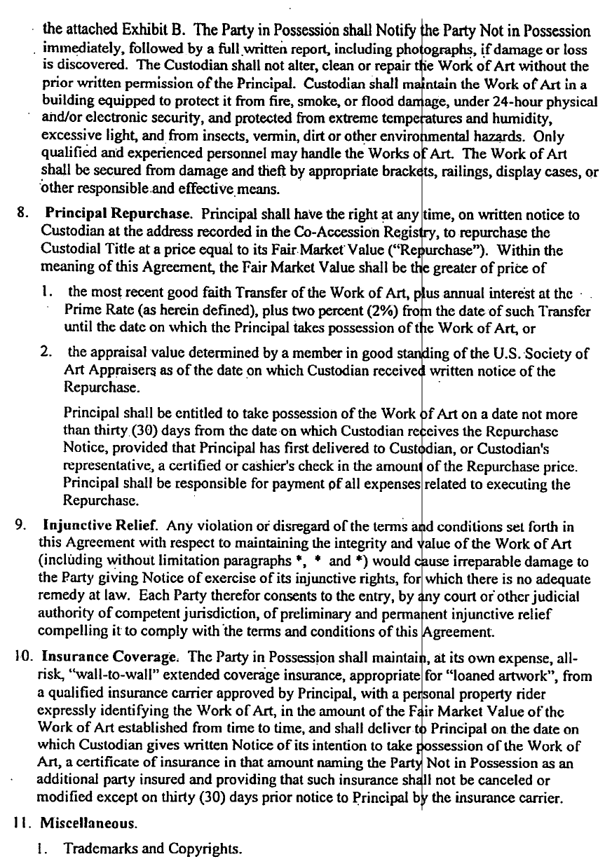

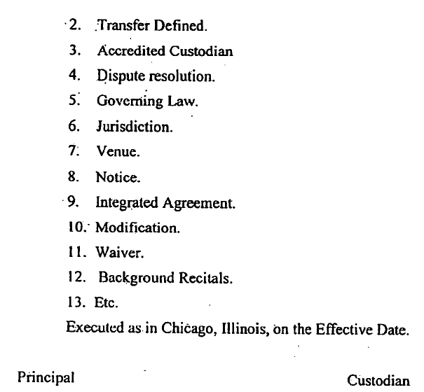

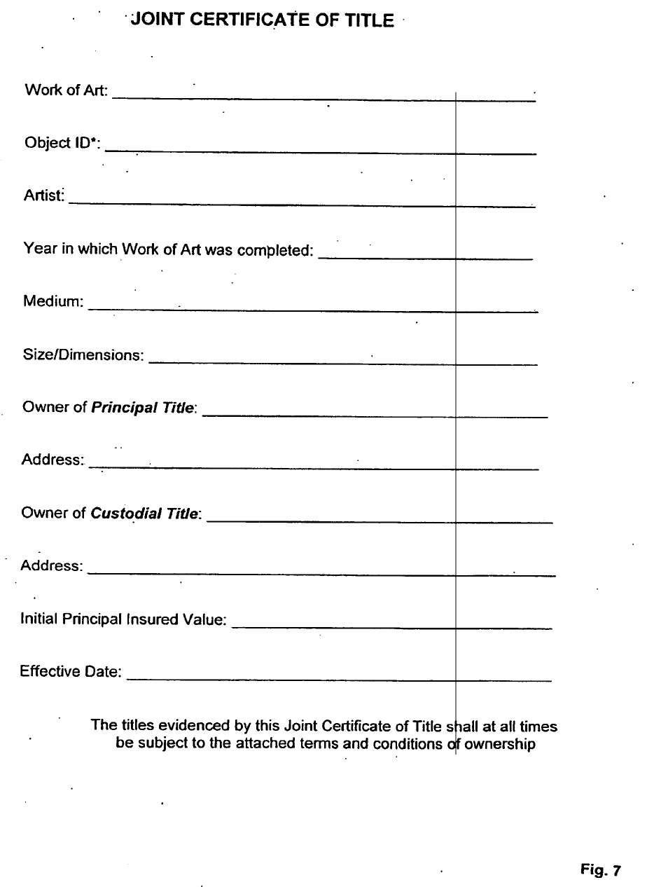

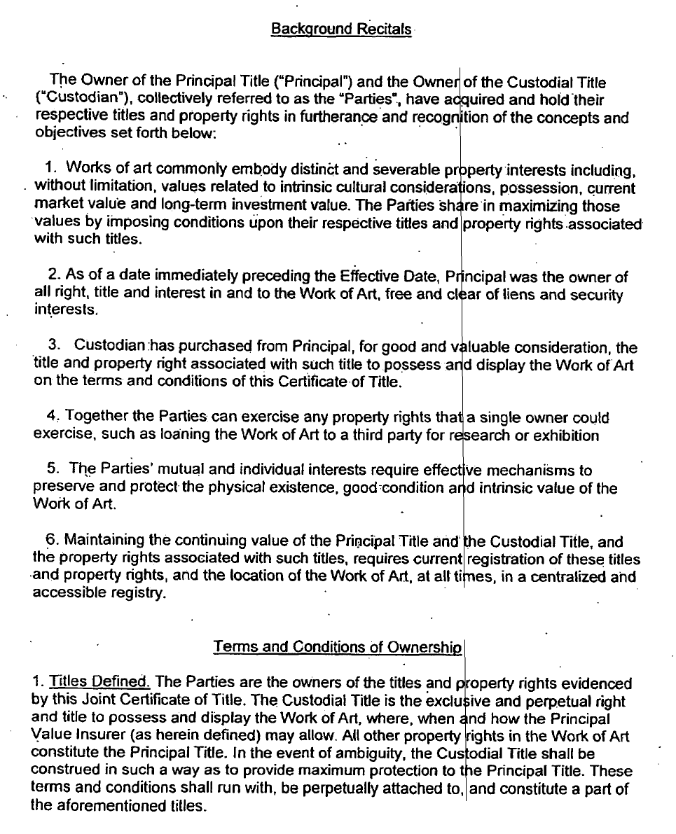

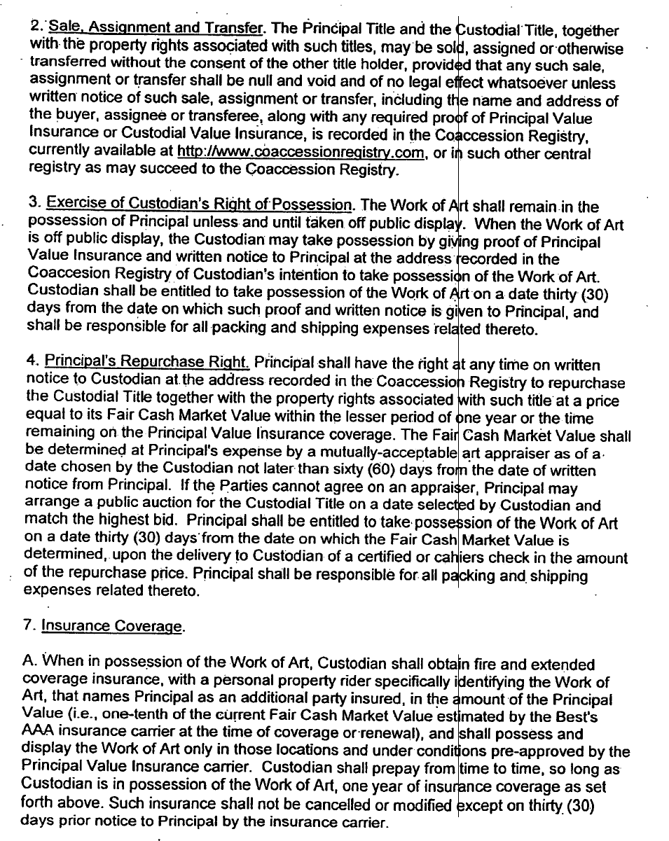

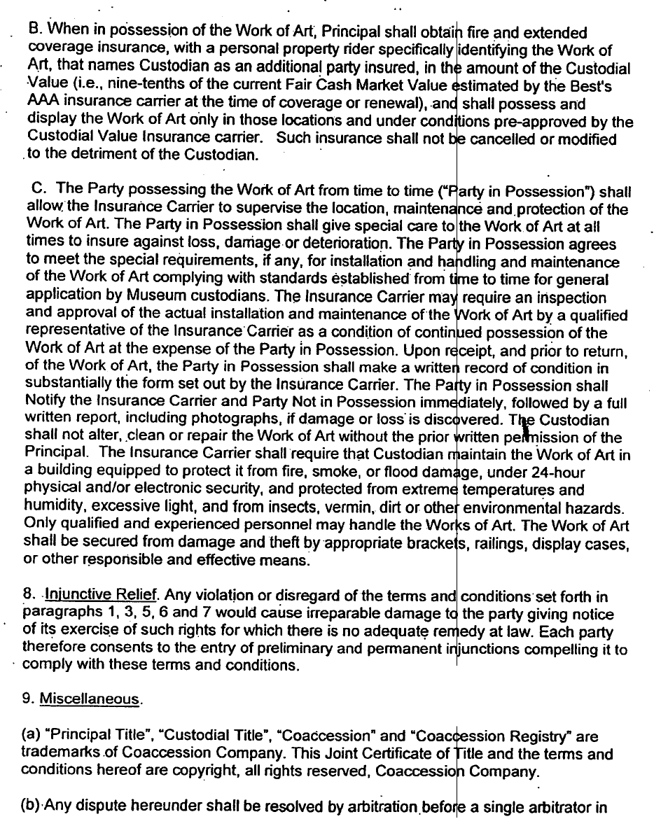

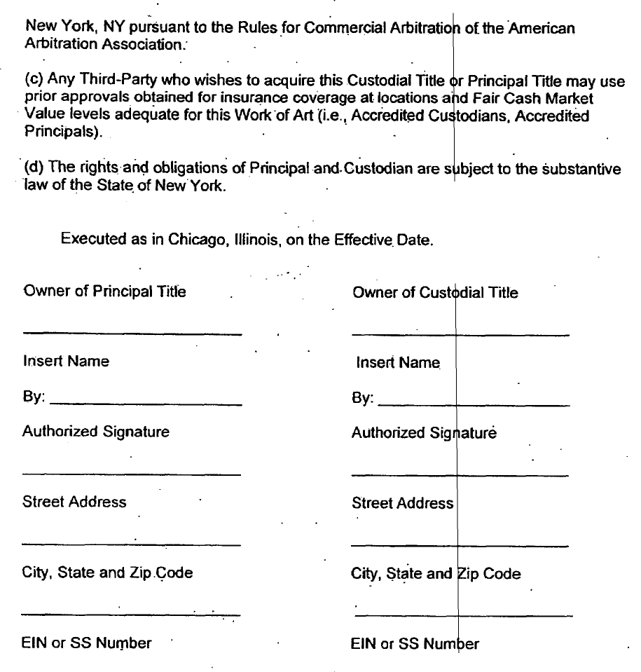

More specifically, an agreement or other document creates a “possessing title.” The document has language to the effect that “The holder of the possessing title has the right to possess the tangible personal or heirloom (or real) property described as (description of object or heirloom (or real estate)) so long as the bearer maintains proper insurance. All other rights to the above-described object or heirloom (or real estate) belong to the bearer of the controlling title. The bearer of the controlling title has the right, with specific performance, to repossess the object or heirloom (or real estate) by calling an auction for the possessing-title and purchasing that title by matching the high outside bid at auction. The agreement or other document creates another title called “controlling-title.” The document has language to the effect that “The holder of the controlling title has all rights except the right to possess the object or heirloom (or piece) of tangible personal or heirloom (or real) property described as (description of object or heirloom (or real estate)). The right to possess the above-described object or heirloom (or piece) belongs to the current bearer of the possessing title so long as the possessing title bearer maintains proper insurance. The holder of the controlling title has the right, with specific performance, to repossess the object or heirloom (or real estate) by calling an auction for the possessing title, and purchasing that title by matching the high outside bid at auction.” This is title division when the full undivided or fee simple title holder holds undivided rights. Examples of agreements creating possessing titles and custodial titles are provided in FIGS. 5-7. It is to be understood that in FIGS. 6 and 7, the terms “Custodian” and “Custodial Title” are interchangeable with the terms “Possessor” and “Possessing Title,” respectively. In addition, in FIGS. 6 and 7, the terms “Principal” and “Principal Title” are interchangeable with the terms “Controller” and “Controlling Title,” respectively.

Title division may occur when the title holder holds rights divided with another rights holder, e.g. an artist with moral rights and droit de suite. In such cases, the document has language to the effect that “The holder of the possessing title has the right to possess the tangible personal property or heirloom property described as (description of object or heirloom) so long as the bearer maintains proper insurance. All other rights to the above-described object or heirloom, except moral rights and droit de suite, belong to the bearer of the controlling title. Moral rights and droit de suite belong to the bearer of the artistic title. The bearer of the controlling-title has the right, with specific performance, to repossess the object or heirloom by calling an auction for the possessing-title and purchasing that title by matching the high outside bid at auction.” The owner of that same single object of tangible personal property (or heirloom of heirloom property) provides a document that creates an artistic title. The document has language to the effect that “The bearer of the artistic title has moral rights and droit de suite to the object of tangible personal property (or heirloom or heirloom property) described as (description of object or heirloom).” The document has language to the effect that “The bearer of the controlling title has all rights except the right to possess, moral rights and droit de suite to the object of tangible personal property (or heirloom of heirloom property) described as (description of object or heirloom). The right to possess the above-described object or heirloom belongs to the current bearer of the possessing title, so long as the possessing-title bearer maintains proper insurance. Moral rights and droit de suite belong to the current bearer of the artistic-title.” This is title division when title holder shares rights with another.

The invention allows for possessing titles in various circumstances that may make different divisions of rights among titles useful. Examples of such circumstances and intended use follow.

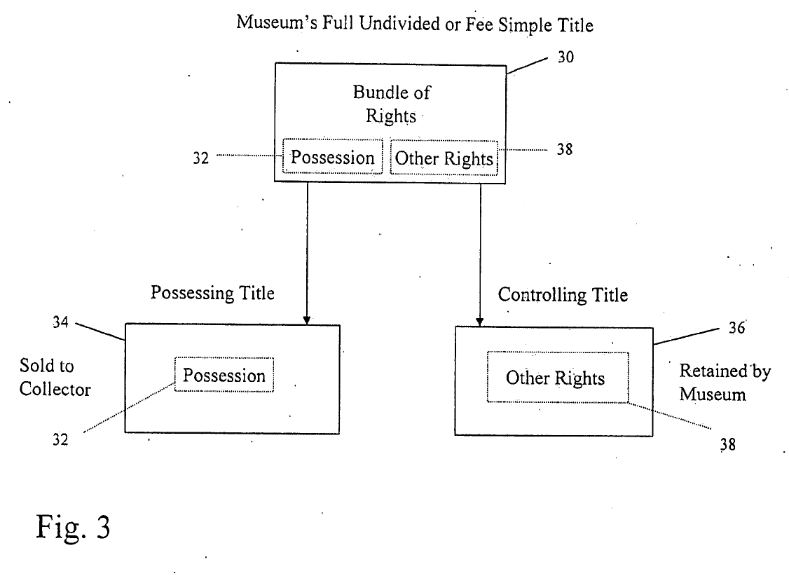

One intended use for the invention is the sale, by a museum to a collector, of a possessing-title to an object held by the museum in its permanent collection, illustrated in FIG. 3. As illustrated in FIG. 3, the museum, a full undivided owner, and thus owner of a full undivided title 30, of a single object of tangible personal property or heirloom of heirloom property or piece of real property unbundles the right of possession 32 from the other rights 38 of the bundle of rights of the full undivided title. As a result, a possessing title 34 including the right of possession 32 and a controlling title 36 including the remaining other rights 38 are created. As illustrated in FIG. 3, the possessing title 34 is sold to a collector, while the controlling title is retained by the museum.

With this transfer of the right to possess the object or heirloom, and its physical possession, the museum reduces its own storage costs while enhancing the collector's enjoyment. The object or heirloom is no longer on the museum's premises for immediate public display or for private inspection by researchers and conservators, but if the museum selects the objects or heirlooms destined for title division with care, the museum will not have any imminent need for such uses. Moreover, enhanced mobility from continuing improvements in communications, transport and logistics steadily reduce any barriers to uses presented by the object's or heirloom's remote location. Once title division resolves incentive incompatibilities between museums and collectors, the remote storage option represents a boon both to museums and collectors, as well as the public in general, which will benefit greatly from the increasing financial and physical capacities of museums to document the world's cultural property before much extant knowledge is irretrievably lost to looting and other hazards, and the decreased risk of a single catastrophe destroying or damaging much of a museum's permanent collection.

A museum might also transfer the right to possess the object or heirloom without imminently transferring physical possession in a “virtual possession” approach. This contingent approach to possessing titles lets museums also get funding from dividing titles to objects or heirlooms that will remain on display. The collector can hold possessing title to an object or heirloom without having to pay storage costs, while the museum maintains the public's enjoyment by continuing to display the object. As a primarily financial investment, the object or heirloom stays on museum premises in a way something like gold an investor may purchase while deposited in a vault, and resell without ever taking possession. The collector could take physical possession for his own private incidental display and enjoyment when the museum takes the object or heirloom off public display, or let the museum continue to store the object or heirloom for private inspection by researchers and conservators. Either way, if the museum selects these objects or heirlooms destined for title division with care, the collector will value their possessing titles as an investment backed by a very desirable asset. Some public acknowledgment by the museum of the collector's investment, such as a plaque next to the object or heirloom on display, could increase the attraction. Possessing titles as primarily financial investments could lend themselves to fractional shares and exchange trading. This virtual possession approach could also work for real estate, such as municipal lands used for parks and schools, with the possessor taking possession once the municipal purpose no longer holds.

In common law, the full undivided or fee simple property title consists of a bundle of rights. Those rights, enforceable by law, let the property owner choose what to do with the object, heirloom or land that is the owner's property. Title division can split off just one right from the bundle—possession—and puts that right into a possessing title. The remaining rights constitute a controlling title, so that the controlling title holder—the controller—still chooses everything to be done with the object or heirloom, while the possessing title holder—the possessor—simply possesses the object or heirloom. To do anything with the object except simply possess it, the possessor needs the controller's permission. To do anything with the object or heirloom that requires physical access, the controller needs the possessor's permission. However, the possessor has no say over the controller licensing existing images of the object or heirloom, for example, since licensing existing images doesn't require physical access. Cooperating, the controller and possessor can do anything a full undivided or fee simple owner could do, such as restore the object or heirloom, loan it for research, or put it on public display. The controller and possessor will agree not to unreasonably withhold, or arbitrarily price, such permissions.

To make title division a desirable invention for both controllers and possessors, it must respect the interests of the possessor as well as the controller. Having sold the possessing title, the controller has the right to repurchase the title at a time of the controller's choosing, but the possessor has the right to a price determined at public auction by the highest outside bid (meaning the possessor cannot make an arbitrarily high bid to himself or herself to retain the title). If the controller matches the high bid, he or she wins the possessing title. If the high bid is more than the controller cares to pay, the possessor may accept the outsider's bid or not. The controller is the only person who can make a possessor accept a bid.

Once a museum has determined that it has no intent to display or research an object or heirloom in its permanent collection in the near future, it may title divide the object or heirloom and sell the possessing title to a collector who wishes to possess the object or heirloom subject to its ongoing control and potential recall by the museum. This eliminates storage costs for the museum by placing the object or heirloom with a counterparty who shares the museum's interest in caring for the object or heirloom in a way that optimizes its condition in perpetuity. It lets the museum determine all other uses for the object or heirloom other than possession, maintaining substantial control over the object or heirloom in perpetuity. It raises funds for the museum by bringing in the purchase price of the possessing title. The museum can then use these funds as well as the storage cost savings to further its mission.

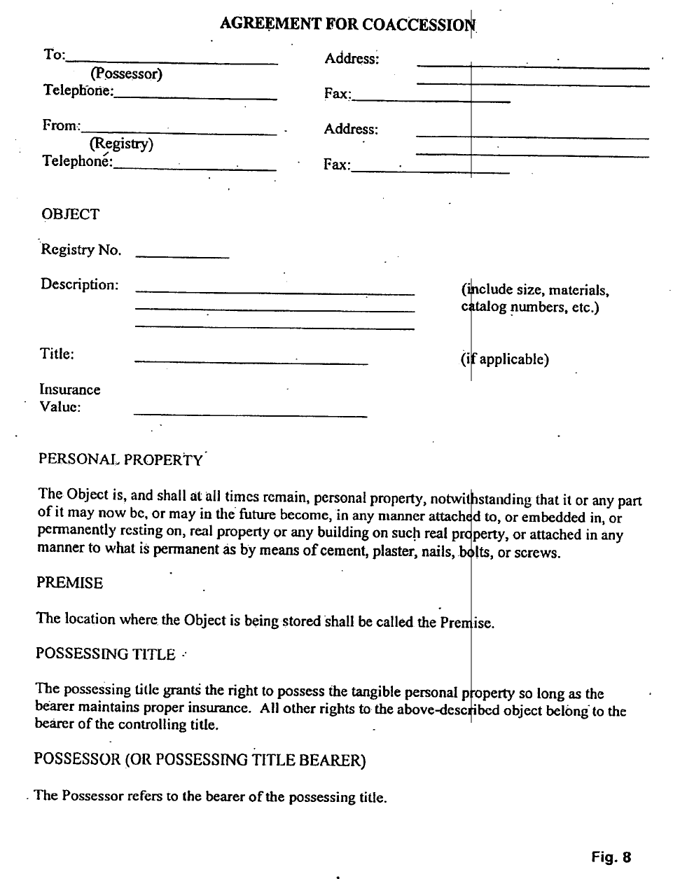

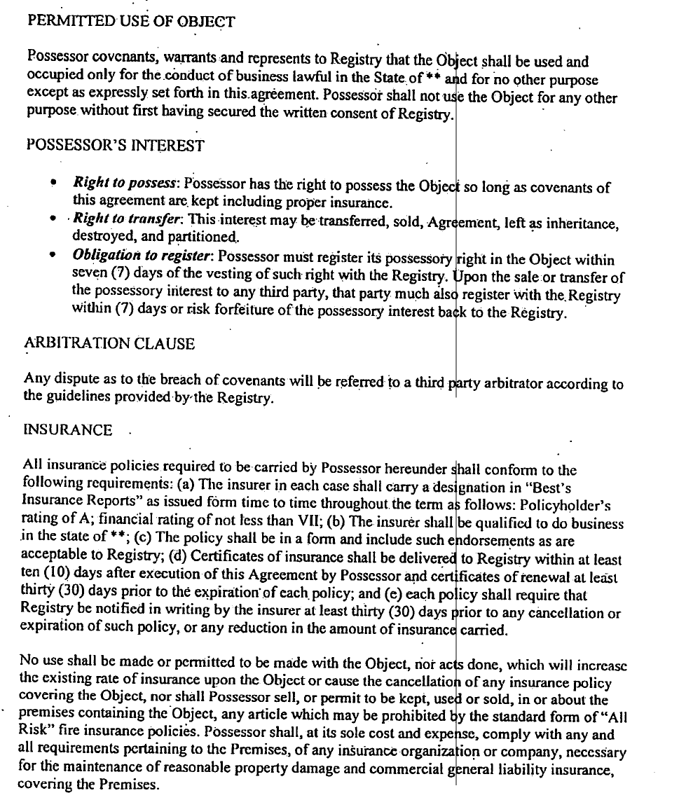

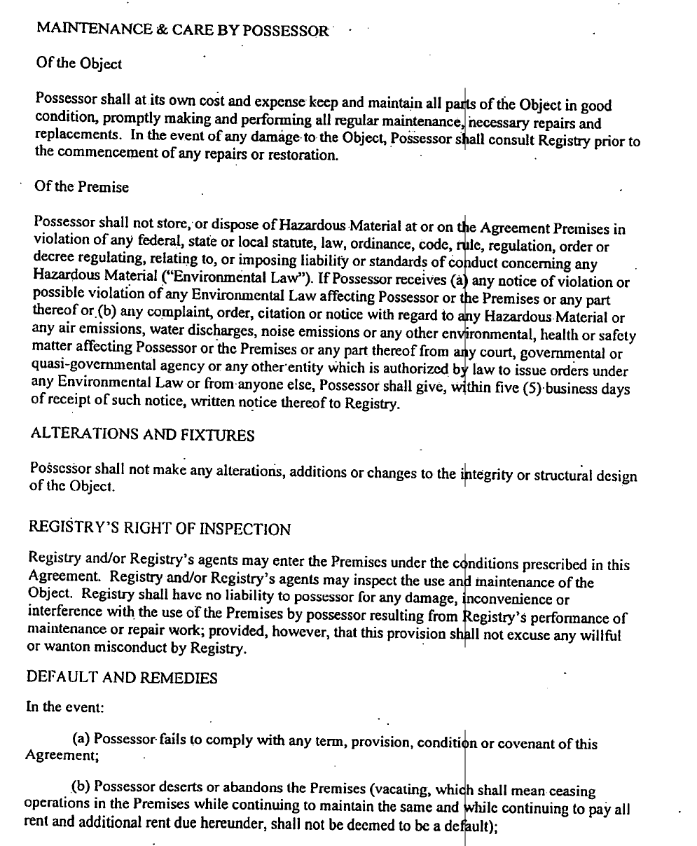

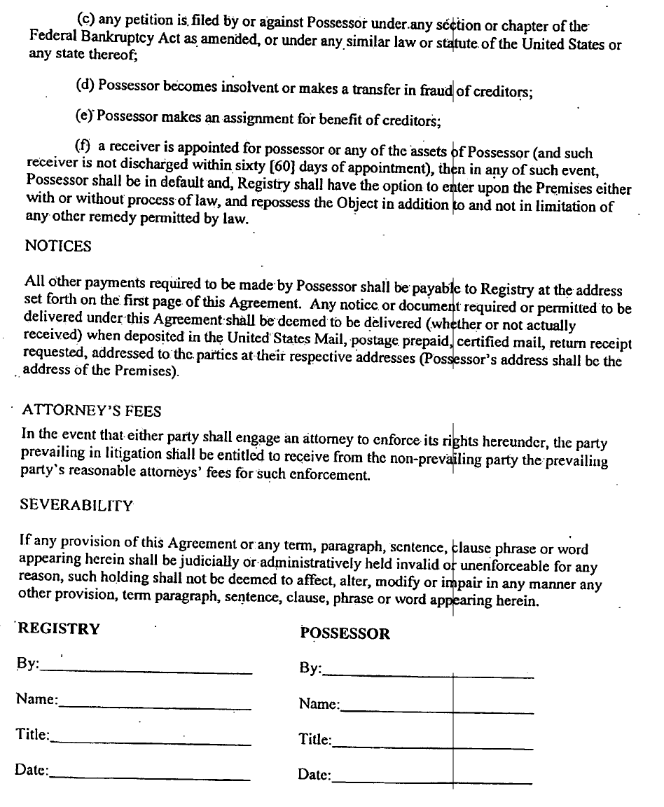

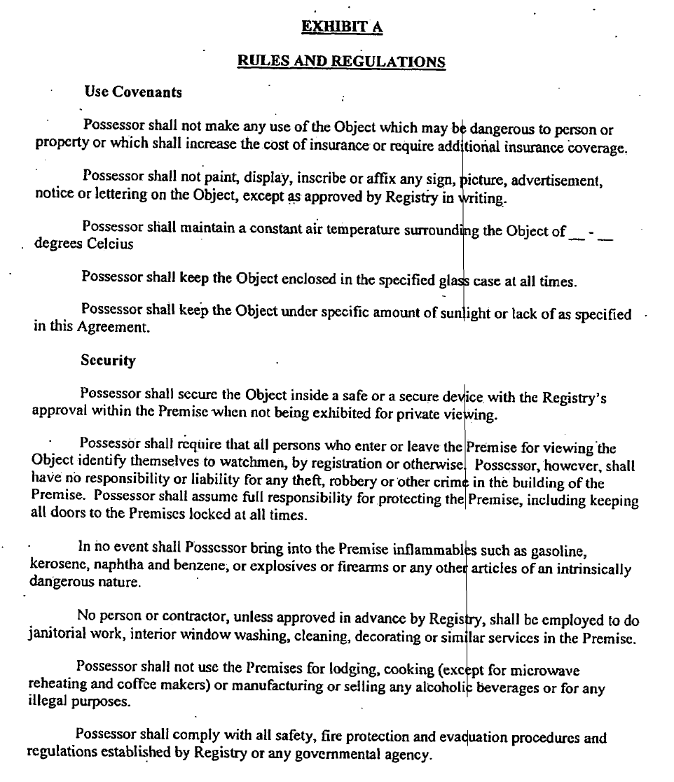

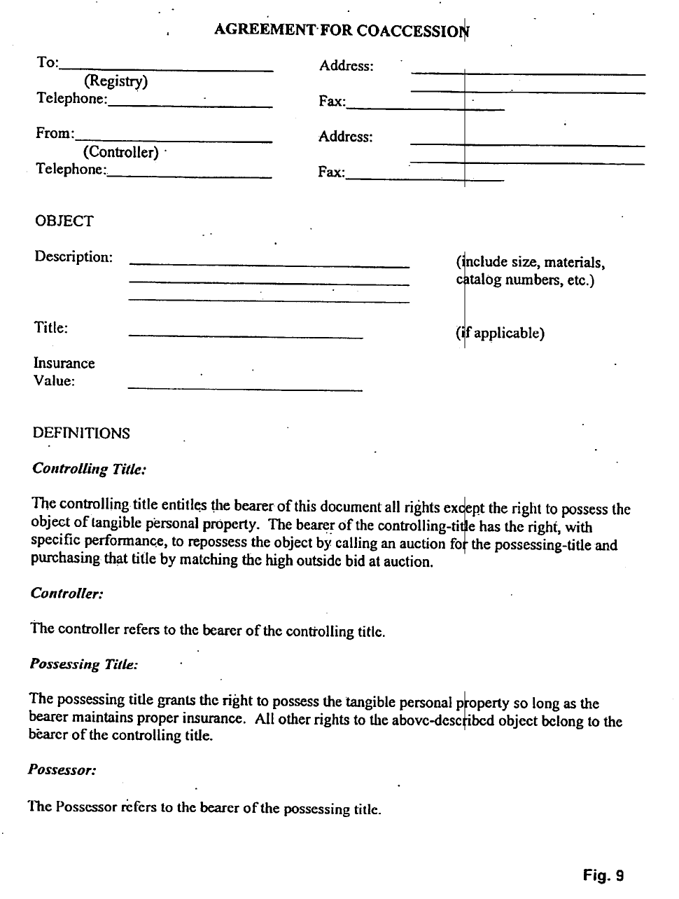

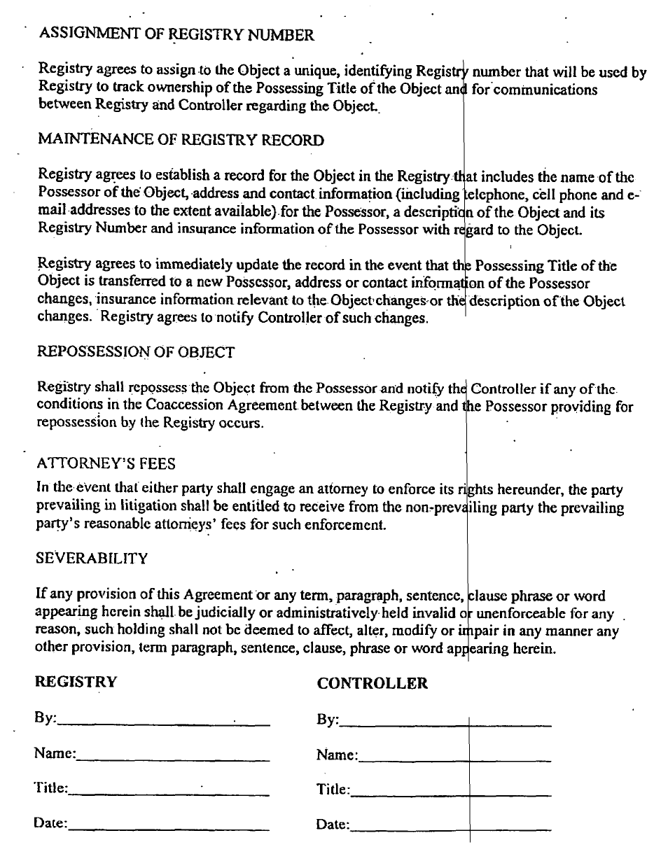

To give the public fair notice that mere possession of a given object or heirloom does not constitute a full undivided or fee simple title with all rights, divided title objects or heirlooms can be listed in a divided title registry. This publicly-accessible registry provides comprehensive imagery and descriptions of all objects or heirlooms whose possessors hold only possessing title, letting anyone considering the purchase of an object or heirloom determine whether that object or heirloom has been title divided so that the possessor's title is only possessing. Examples of agreements between such a registry and a possessor (holder of a possessing title) and a controller (holder of a controlling title) are provided in FIGS. 8 and 9.

As an example, the registry would include, at a minimum, the information entered into the fields of the first pages (top halves) of the agreements of FIGS. 8 and 9.

Thanks to the Internet, consulting the divided title registry requires minimal time and effort. Over time, the divided title registry could evolve into one of the world's most accessible and comprehensive catalogs of objects or heirlooms of interest to scientists and humanists, and become a major resource for both professionals and amateurs. With its critical mass of object descriptions for objects or heirlooms already title divided, the divided title registry could be a useful site for museums to not only post descriptions of objects or heirlooms available for future title division, but also objects or heirlooms available for onsite display and research at museum facilities—a universal catalog.

Title division's division of property rights raises an issue of insurance. The possessor and the controller share an interest in the object's or heirloom's care and security, since both titles lose value if a hazard damages or destroys the object or heirloom. Nonetheless, the possessor's loss is not the full loss in the instance of a hazard, so while the possessor has the same kind of incentive to protect the object or heirloom as the controller, the possessor does not as much incentive alone to secure the object or heirloom from hazards as the possessor and controller do together. Consequently, ensuring full incentive compatibility requires that the possessor insure the controller for the loss of value to the controlling-title in the instance of a hazard. Thus, insurance companies will act as agents for the controller and advisors for the possessor, employing conservators to track the possessor's care and security for the object or heirloom and adjust the controlling title premium to reflect the risks to which the possessor exposes the object or heirloom. Through premiums covering their own losses and the controller's as well, possessors pay the full cost of the risks, and insurance companies compensate the controllers for any losses due to hazards.

If a possessor cannot or will not maintain coverage for the controller's risks, then the possessing title goes to public auction where the controller can either match the high bid to retake possession of the object or heirloom, or let the high bidder take the possessing title along with new possession of the object or heirloom. In either case, the defaulting possessor gets the net proceeds of the auction after deductions for any expenses, unpaid premiums and liens (possessing titles, like any transferable asset, could be financed or used as loan collateral).

Since insurance companies will collect controlling title premiums on a regular basis, they're the ideal parties to maintain the divided title registry. As long as the possessor wishes to keep possession, insurance firms will receive notice of any changes, because a gap in payments will trigger an auction to take away the possessing title. If a possessor sells the possessing title to a new possessor, the old possessor will notify the insurance company of that transfer to end the obligation to pay controlling title premiums on the object or heirloom, and the new possessor will notify the insurance company to avoid having the possessing title put out to auction.

To increase the liquidity of possessing titles to major objects or heirlooms, insurance and other financial companies may pre-qualify bidders to participate in possessing-title auctions, creating a class of “qualified collectors” analogous to the class of “qualified investors” who can invest directly in such unregulated financial offerings as hedge funds and venture capital funds. Just as some qualified investors can invest in all types of offerings and others can only invest in venture capital, some qualified collectors could collect the most valuable objects or heirlooms while others would only qualify for lesser objects or heirlooms. Prequalification would rate not only financial capacity, but also the physical environment where the collector would display the object or heirloom. With expert assessments by conservators, the prequalification report would be an analogue to the facilities report used by museums to evaluate the loan-worthiness of other museums.

For minor objects or heirlooms, museums may offer possessing titles to museum members and the general public without prequalification. Robust objects or heirlooms may stand alone, while museums may minimize the risks to more sensitive objects or heirlooms by sealing them in presentation cases suitable for display. For example, even delicate, light-sensitive objects or heirlooms could be offered for title division as long as the display case's glass had appropriate filters to prevent lumens on the object or heirloom from exceeding recommended limits, while objects or heirlooms requiring low humidity could be sealed in cases with a dehumidifier (access to electricity would be one of the possessing-title maintenance conditions). Opening a sealed case would be grounds for an immediate auction of the possessing-titles, and insurers could monitor the condition of the case could externally to the home by including powerful radio frequency identification (RFID) tags.

Museums need not wait until objects or heirlooms are already in their collections before offering possessing titles. Those without existing collections but with access to source sites can pre-sell possessing titles to objects or heirlooms expected to be collected in an expedition, offering purchasers points based on their financial contribution to the overall expedition, and auctioning discovered objects or heirlooms for expedition points after the expedition has run its course. Expedition operators should warn collectors regarding the highly speculative nature of point investments, and possibly restrict investments to qualified collectors. Still, financial risks do not justify heavy regulation, since the public good, scientific knowledge, which expeditions produce with certainty can salve the pains from any financial setbacks suffered by committed collectors.

By creating these compatible incentives that let museums sell possessing-titles that move their objects or heirlooms into secure locations outside the museum, title division gives museums an innovative solution the challenge of storage, which is surprisingly important. Collections grow, and as long as museums store their entire collection within their premises, those premises must grow to match the collection. Furthermore, proper storage space is expensive to build and maintain, so financial constraints force many museums to compromise the quality of their storage. Natural history museums have 98% of their collections in storage, art museums 80%. Without title division or some other effective alternative to current practices, rising storage costs represent a real threat to museums' capacities to preserve and display cultural property for the public good. As Glenn D. Lowry, Director of the Museum of Modern Art in New York, observed, “Over the next 50 years a fairly large number of American museums will have to decide whether to curtail their activities drastically or to deaccession substantial parts of their collections” (ARTnews, March 1998). As Ann Stone comprehensively documents in her doctoral dissertation, “Treasures in the Basement,” leading museum experts, museum organizations and museums have published studies of storage problems all around the world without pointing to any viable solutions to problem generated by exponentially-growing collections.

By moving stored items into the community while preserving control and access, title division lets museums accommodate many more objects or heirlooms in their permanent collections than they could if they were limited to storage on their own premises. Removing these constraints to the growth of museum collections enriches the community not only through more comprehensive collections, but also by letting people appreciate museum collections by direct observation in their homes, offices, schools, churches, hospitals and so on, rather than just with the knowledge that museums have those objects or heirlooms tucked away in some basement inaccessible to the public. Removing storage constraints will also let museums collect many more antiquities, fossils and other objects or heirlooms at risk in their source sites than they could if they had to pay for conventional storage.

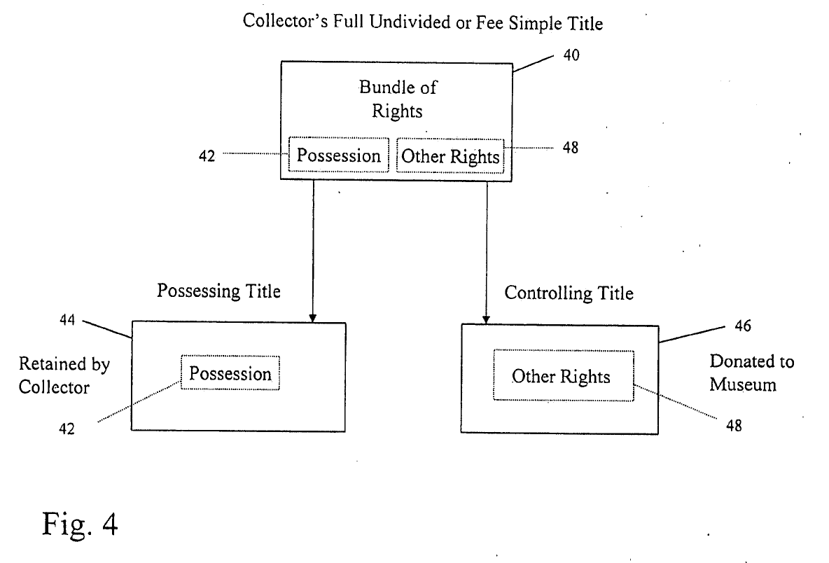

While museums could be the main users of title division, other users have possible applications in the museum field, collectors wishing to donate objects or heirlooms to museums could commit to a chosen museum while continuing to enjoy possession of an object or heirloom by title dividing that object or heirloom, keeping the possessing title, and donating the controlling title to that museum. Such an arrangement is illustrated in FIG. 4. As illustrated in FIG. 4, a collector, a full undivided or fee simple owner, and thus owner of full undivided or fee simple title 40, of a single object of tangible personal property, heirloom of heirloom property or piece of real property unbundles the right of possession 42 from the other rights 48 of the bundle of rights of the fee simple title. As a result, a possessing title 44 including the right of possession 42 and a controlling title 46 including the remaining other rights 48 are created. As illustrated in FIG. 4, the possessing title 44 is retained by the collector, while the controlling title 46 is donated to a museum.

Collectors with a temporary need for cash and an aversion to debt might title divide an object or heirloom, sell the possessing title, invest the cash and repurchase the possessing-title at a later date. A museum targeting the accession of a particular object or heirloom to its collection might solicit the donation or purchase of a possessing-title as a fallback position if that object's or heirloom's owner was currently unwilling to donate or sell that museum a full undivided or fee simple title outright. Parallel uses for title division with real property might arise beside its use by conservancies.

Using the present divided property titles invention optimally for the inventor's purposes involves promoting the rescue of knowledge in peril as well as earning royalties on various uses. Accordingly, the inventor's best mode creates an non-profit organization with a royalty-free license to divide full undivided or fee simple titles into possessing and controlling titles for individuals and organizations that will use these titles to rescue knowledge in peril, as well as a for-profit organization that pays a royalty to the inventor to create possessing and controlling titles for individuals and organizations using them for all other purposes. The best mode requires a second non-profit organization that creates and maintains a public registry of all possessing and controlling titles, providing constructive notice to all regarding these properties not held in full undivided or fee simple title.

In accordance with the present invention, a non-profit royalty-free licensing organization (RFLO) may divide property titles for individual and organizations that will use these possessing and controlling titles to rescue knowledge in peril (KIP). It may charge possessing title purchasers for title division services (it may not charge possessing title sellers using its services since they will use funds raised to rescue KIP). Accomplishing that goal requires defining knowledge in peril; accordingly, the RFLO may assemble an advisory council to create a list of KIP sites where the risks to knowledge rise to the level of imminent threat. When an individual. or organization wants to divide a full undivided or fee simple title into possessing and controlling titles for any property whose sales proceeds are destined to help fund a conservancy or collecting expedition for a KIP site (i.e., KIP-friendly property), the RFLO may divide the full undivided or fee simple title without paying any royalty to the inventor for the use of title -division. If a site is not on the KIP list, the prospective title holder can submit the relevant facts to the advisory council and ask for a ruling.

The RFLO may set standards for expeditions supported by royalty-free transactions. These will include: transparency, with comprehensive video documentation of expedition activities and immediate announcements of discoveries; commitments to source site neighbors, with local training for excavation, processing, curation, and conservation and permanent construction of expedition facilities, including power generation and Internet connections, for later donation to a local museum; and timely research on all unique objects or heirlooms recovered, which implies access for non-expedition personnel if discoveries exceed the expedition team's own capacities.

The RFLO may coordinate work to discover KIP sites, seeking access to earth sensing data that can map anomalies indicative of scientific productivity from all sources, including military, geophysical, farming, and forestry organizations. The RFLO may reward locals who identify and protect KIP sites, and promote amnesties for locals who abandon black market transactions in timely fashion.

The RFLO can use its cost advantage to provide lower-cost services to title holders who will rescue knowledge, but it should also promote knowledge rescue to the public in general. Accordingly, a range of public services for the RFLO beyond just dividing property titles is possible. The services include, but are not limited to, an online catalogue offering possessing-titles to KIP-friendly property available for purchase from a variety of sources, brick-and-mortar retail operations offering possessing-titles to KIP-friendly property to the public (alone or in collaboration with collecting and conserving organizations), and essay contests, with prizes of possessing-titles to KIP-friendly property, open to, disabled and economically-disadvantaged individuals as well as organizations that primarily aid such individuals. The essays would explain why a particular KIP-friendly property is important to that individual or organization, and the prizes, often consisting of the particular KIP-friendly property that the essay discusses, would provide the individual or organization an asset that is not only importantly culturally to that individual or organization, but additionally offers a measure of financial security should circumstances arise that require ready cash.

The RFLO may devote its own operating surpluses in excess of growth financing needs to purchasing KIP-friendly property prizes, as well as specifically soliciting funds to purchase more prizes for more contests. Various foundations have the mission to support cultural outreach, and the mission other foundations have the mission to help individuals acquire financial assets. Such foundations should enthusiastically support the RFLO's method of providing assets that are simultaneously cultural and financial to deserving individuals and organizations. Individuals and organizations earn the assets by submitting winning essays that demonstrate their appreciation for that particular asset's cultural value. The deserving organizations (such as schools, churches, hospitals, settlement houses and the like) qualify by primarily working with populations predominantly of deserving individuals and win by submitting winning team essays.

The RFLO would work with universities to create video production internships giving students opportunities to work with the RFLO's professionals in documenting KIP rescues.

The RFLO will work with airlines, hotels and other travel-related business to promote cultural tourism, generating added cash flows for expeditions and local museums.

In accordance with the present invention, a for-profit royalty-paying licensing organization (LO) may divide property titles for individuals and organizations who will not use these possessing and controlling titles to rescue knowledge in peril (KIP). It may charge freely for its title division services. It is incorporated, and issues shares to the public and employees in return for the value generated from ideas that they submit to the corporation's innovation plan. One idea or a thousand earn the first share; subsequent shares only come from value added. The innovator shares value earned with innovators of predecessor ideas the current idea builds upon, and receives value from successor ideas that build upon the current idea. The LO works with dealers and auctions to enhance liquidity for possessing titles and controlling titles.

Since the LO's program is open to the public, it lets RFLO employees capitalize the innovative licensing ideas their experience helps them generate. In turn, the LO provides ongoing support to the RFLO by letting the RFLO apply LO licensing innovations without charging any royalties. This lets RFLO employees earn equity for their innovations even as they apply them in a non-profit organization.

In accordance with the present invention, a non-profit registry organization (RO) works with insurance firms, insurance industry associations, other registries for personal and real property, and standard-setting bodies for object identification to maintain a complete list of all properties with divided titles, including current holders of controlling titles, .possessing titles, and other titles such as artist titles. The registry will include current insurance coverage in the information on holders, and notify current controlling-title holders of any lapse in coverage by a current possessing title holder.

The RO will pre-register objects or heirlooms available for title division, and collaborate with both the RFLO and the LO to make possessing-titles for such objects or heirlooms searchable at one location. The RFLO would generally cross-list available possessing titles for pre-registered objects or heirlooms on the RFLO and sub-licensee websites as possible prizes for essay contests as well as possible purchases. The LO and sub-licensee websites would list pre-registered possessing titles as available for purchase.

The RO helps provide a public good by ensuring that buyers seeking information on the title to an object or heirloom can rely on one source to provide a comprehensive registry of all divided titles. The RO's advantage in the number of divided titles registered, as well as its established reputation and procedures, should ensure that information about the bulk of all divided titles continue to be available at one source. If competitors arise in providing title division and related services, the RO's established position would let it take the lead in providing links between competing registries to allow cross-referenced title searches that can continue the tradition of offering the public a single comprehensive title search for divided titles

The RO may work with the RFLO and LO to aggregate statistics on various parts of the title division market, carefully reporting information in ways that will not allow the calculation of results for individual transactions or organizations. The RO, RFLO, and LO would jointly publish price indices and value indices (possessing title vs. full undivided or fee simple title) for various aggregate groups. Futures exchanges might trade these indices as divided title markets gain liquidity.

The RO will work with other object or heirloom registries, such as stolen objects registries, registries of security interests in personal property, museum and library catalogues and the like, to create more comprehensive listings of unique, valuable or important objects and heirlooms.

While the preferred embodiments of the invention have been shown and described, it will be apparent to those skilled in the art that changes and modifications may be made therein without departing from the spirit of the invention, the scope of which is defined by the appended claims.

What is claimed is:

1. A method of dividing ownership of a piece of property comprising the steps of:
a. creating a possessing title for the piece of property including the right of possession; and
b. creating a controlling title for the piece of property including a number of remaining rights.

2. The method of claim 1 wherein the property is personal property.

3. The method of claim 1 wherein the property is an heirloom property.

4. The method of claim 1 wherein the property is real property.

5. The method of claim 1 further comprising the steps of:
c. registering the possessing title with a registry; and
d. registering the controlling title with the registry.

6. The method of claim 1 wherein the remaining rights include the right to repurchase the possessing title.

7. A method of dividing ownership of a piece of property comprising the steps of:
a. creating multiple titles for the piece of property; and
b. registering the multiple titles with a central registry.

8. The method of claim 7 wherein the multiple titles include
a. a first divided title including a first set of ownership rights; and
b. a second divided title including a second set of ownership rights.

9. The method of claim 8 wherein the first divided title is a custodial title and the first set of ownership rights include the right to possess the piece of property.

10. The method of claim 9 wherein the right to possess the piece of property includes virtual possession.

11. The method of claim 9 wherein the second divided title is a principal title and the second divided title right includes the right to repurchase the custodial title at a price equal to its fair market value.

12. The method of claim 7 wherein the property is personal property.

13. The method of claim 7 wherein the property is an heirloom property.

14. The method of claim 7 wherein the property is real property.

15. The method of claim 8 further comprises the steps of:
c. creating a registration agreement for the first divided title with a registry; and
d. creating a registration agreement for the second divided title with the registry.

16. A system for divided title ownership of a piece of property including:
a. a registry;
b. a possessor owning a possessing title for the piece of property;
c. a controller owning a controlling title for the piece of property;
d. an agreement between the possessor and the registry regarding the piece of property; and
e. an agreement between the controller and the registry regarding the piece of property.

17. The system of claim 16 wherein the agreement between the possessor and the registry requires the possessor to maintain insurance for the piece of property.

18. The system of claim 16 wherein the agreement between the possessor and the registry requires the possessor to notify the registry if ownership of the possessing title changes.

19. The system of claim 16 wherein the agreement permits the possessor to subdivide the possessing title.

20. The system of claim 16 wherein the possessing title includes virtual possession.
